(19) United States
(12) Patent Application Publication
(10) Pub. No.: US 2025/0170603 A1
(43) Pub. Date: May 29, 2025

(54) ONE-BUTTON SHOWER HEAD WITH PAUSE FUNCTION

(71) Applicant: RUNNER (XIAMEN) CORP., Xiamen (CN)

(72) Inventors: Wenkun LIN, Xiamen (CN); Yuanyuan XU, Xiamen (CN); Zhaoyi ZHUO, Xiamen (CN); Wenhua YE, Xiamen (CN); Shengchao DAI, Xiamen (CN)

(73) Assignee: RUNNER (XIAMEN) CORP., Xiamen (CN)

(21) Appl. No.: 18/959,757

(22) Filed: Nov. 26, 2024

(30) Foreign Application Priority Data
Nov. 29, 2023 (CN) 202311631136.8

(51) Int. Cl. B05B 12/00; B05B 1/18

(52) U.S. Cl. CPC B05B 12/0026; B05B 1/18

(57) ABSTRACT

A one-button shower head with a pause function includes a water outlet body having a cavity and an upper cavity configured to communicate with the cavity, where a water outlet and a water channel are formed in the water outlet body; the water outlet and the water channel are distributed on the water outlet body at an outer circumferential side of the cavity; a rotatable water distribution disc is provided in the upper cavity; a lower end of the water distribution disc is cooperatively connected to an upper end of the cavity; a baffle is provided on the water distribution disc; a passage configured to communicate the cavity with the upper cavity is provided at a middle of the water distribution disc; and a water passing port configured to communicate with the water outlet is formed in the water distribution disc and located at a side of the passage.

### CROSS REFERENCE TO THE RELATED APPLICATIONS

This application is based upon and claims priority to Chinese Patent Application No. 202311631136.8, filed on Nov. 29, 2023, the entire contents of which are incorporated herein by reference.

### TECHNICAL FIELD

The present disclosure relates to a one-button shower head with a pause function.

### BACKGROUND

At present, the multifunctional one-button shower head in the market is usually not provided with a pause function (the paused state means a small flow of water, such as <0.5 gpm/min, rather than no supply of water). For a shower head with the pause function, a water distribution member and a pause member are provided separately at two positions to cause a large overall size and a complex structure. When spray is switched to pause, the direction of the water flow and the switching direction are problematic. Consequently, the force required for switching is relatively large, and the forces required in the whole replacement process are not balanced.

### SUMMARY

An objective of the present disclosure is to provide a one-button shower head with a pause function, to solve the above technical problem.

The present disclosure is achieved by the following technical solutions:

A one-button shower head with a pause function includes a water outlet body having a middle provided with a cavity, where a water outlet and a water channel configured to communicate with the cavity are formed in the water outlet body; the water outlet and the water channel are distributed on the water outlet body at an outer circumferential side of the cavity; the one-button shower head with a pause function further includes an upper cavity configured to communicate with the cavity; a water distribution disc configured to rotate is provided in the upper cavity; a lower end of the water distribution disc can be cooperatively connected to an upper end of the cavity; a baffle configured to obstruct a water outlet end of the water channel is provided on the water distribution disc; a passage configured to communicate the cavity with the upper cavity is provided at a middle of the water distribution disc; and a water passing port configured to communicate with the water outlet is formed in the water distribution disc and located at a side of the passage.

In the embodiment of the present disclosure, at least two water outlets are formed in an upper end surface of the water outlet body; the water outlets respectively correspond to waterways of different water outlet sprays in the water outlet body; the water outlets, the waterways and the water channel are annularly distributed at the outer circumferential side of the cavity; a sealing ring configured to be in sealing fit with a lower end surface of the water distribution disc is provided at the water outlets and an opening of the upper end of the cavity; and a water flow in the cavity can only flow through the passage, the water passing port and the water outlets sequentially to the waterways.

In the embodiment of the present disclosure, the water outlet end of the water channel can be connected transversely to the cavity; the baffle can be inserted vertically into the cavity and rotates in the cavity synchronously with the water distribution disc; and the passage is provided at an inner circumferential side of the baffle.

In the embodiment of the present disclosure, a lower end of the cavity is further provided with an annular groove, and a lower end of the baffle can be inserted into the annular groove.

In the embodiment of the present disclosure, the one-button shower head with a pause function further includes a water inlet body; the water inlet body can be cooperatively connected to the water outlet body; the upper cavity can be formed between the water inlet body and the water outlet body; the water distribution disc is provided in the upper cavity and can be in sealing fit with the water outlet body; a water inlet passage is provided in the water inlet body; and the water inlet passage can communicate with the water channel.

In the embodiment of the present disclosure, the lower end of the water distribution disc is provided with the baffle configured to be inserted into the cavity, and an upper end of the water distribution disc is provided with a rotating shaft; the rotating shaft can rotate synchronously with the water distribution disc; a transverse flow channel is provided between the rotating shaft and the water distribution disc; the flow channel can communicate with the passage arranged vertically; an end of the rotating shaft can extend out of the upper cavity and can be connected to a drive mechanism; and the drive mechanism is configured to drive the rotating shaft to rotate.

In the embodiment of the present disclosure, the drive mechanism includes a ratchet wheel and a gear cooperating with each other; the ratchet wheel is sleeved on the rotating shaft and can rotate synchronously with the rotating shaft; a first bump is arranged annularly at an end surface of the gear facing the ratchet wheel; a second bump is arranged annularly at an end surface of the ratchet wheel facing the gear; a first mating surface is provided at one side of the first bump; a second mating surface is provided at one side of the second bump; and through cooperation between the first mating surface and the second mating surface, the gear can drive the ratchet wheel to rotate synchronously.

In the embodiment of the present disclosure, a latch is further provided on the rotating shaft; the latch is configured to limit the gear and the ratchet wheel on the rotating shaft; the ratchet wheel is provided above the gear; a spring is further provided between the ratchet wheel and the latch; the ratchet wheel is further configured to move axially along the rotating shaft; a first oblique surface is provided at the other side of the first bump; a second oblique surface is provided at the other side of the second bump; through cooperation between the first oblique surface and the second oblique surface, the gear can rotate, and the ratchet wheel moves axially without rotation.

In the embodiment of the present disclosure, the drive mechanism further includes a moving member; a rack configured to drive the gear to rotate is provided on the moving member; a reset spring is further provided between the moving member and the water inlet body; the rack can move back and forth through the reset spring; the drive mechanism further includes an elastic piece; and one end of the elastic piece is connected to the water inlet body, and the other end of the elastic piece is configured to cooperate with a ratchet of the ratchet wheel to prevent the ratchet wheel from rotating reversely.

In the embodiment of the present disclosure, the one-button shower head with a pause function further includes a connector; a middle of the connector is hinged to the water inlet body; and one end of the connector is connected to the moving member, and the other end of the connector is cooperatively connected to a button.

The one-button shower head with a pause function provided by the present disclosure has the following beneficial effects: 1. With the button switching and the pause function, the demand of the user on daily frequent pause can be met. 2. With the one-button switching, the operation is simple and convenient. 3. The force for switching each function is stable, such that a better switching hand feeling is achieved. 4. The water distribution disc and the baffle for pausing the water are designed synchronously, so the original separate design is changed. The present disclosure effectively reduces the overall footprint of the shower head, and makes the whole shower head less troublesome on the premise of guaranteeing the pause of the multifunctional machine.

### BRIEF DESCRIPTION OF THE DRAWINGS

To describe the technical solutions in the present disclosure more clearly, the drawings required for describing the embodiments or the prior art will be briefly described below. Apparently, the drawings in the following description show merely some embodiments of the present disclosure, and those of ordinary skill in the art may still derive other drawings from these drawings without creative efforts.

FIG. 1 is a schematic view according to the present disclosure;

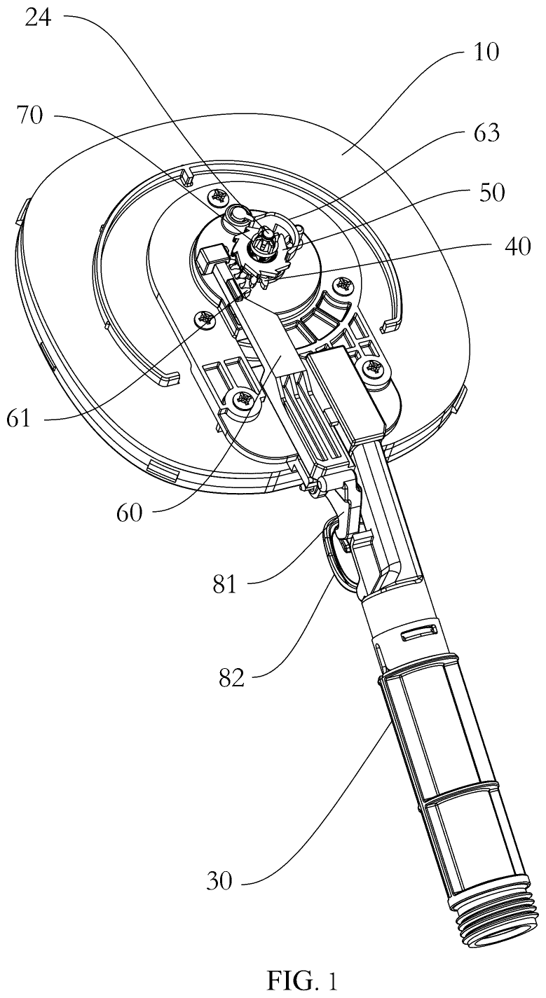

FIG. 2 is a schematic view illustrating cooperation of a drive mechanism according to the present disclosure;

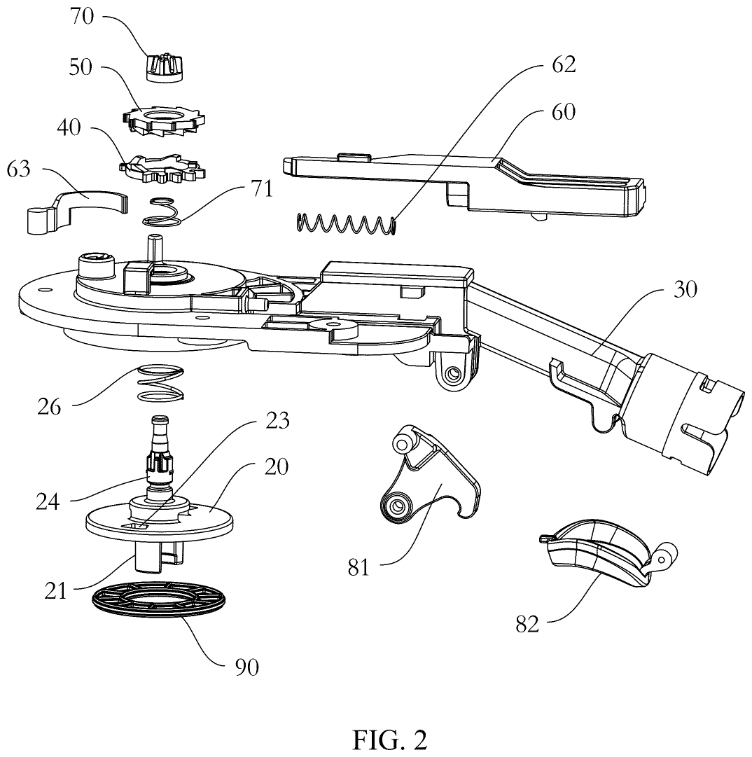

FIG. 3 is a schematic view of a first state according to the present disclosure;

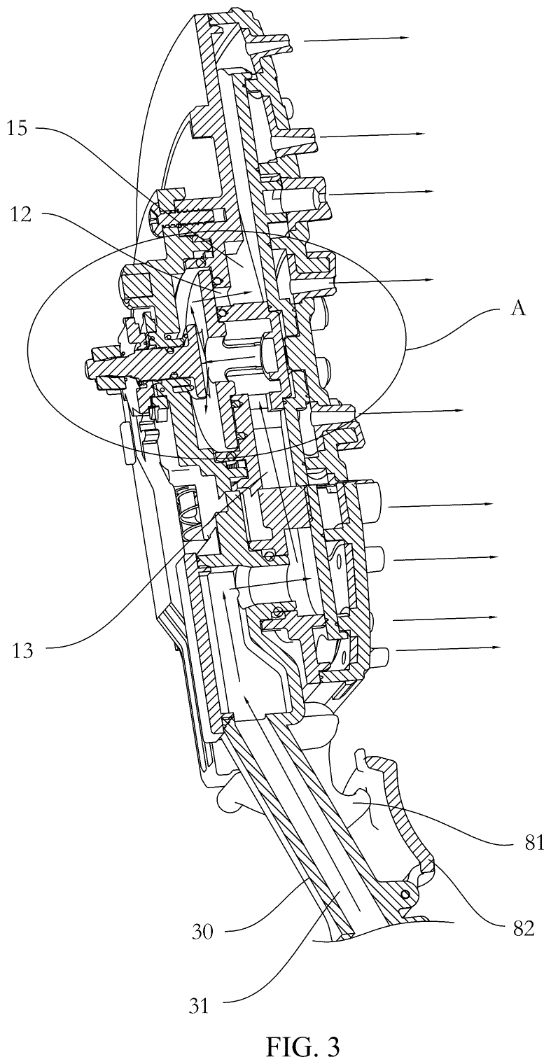

FIG. 4 is a schematic view of a paused state according to the present disclosure;

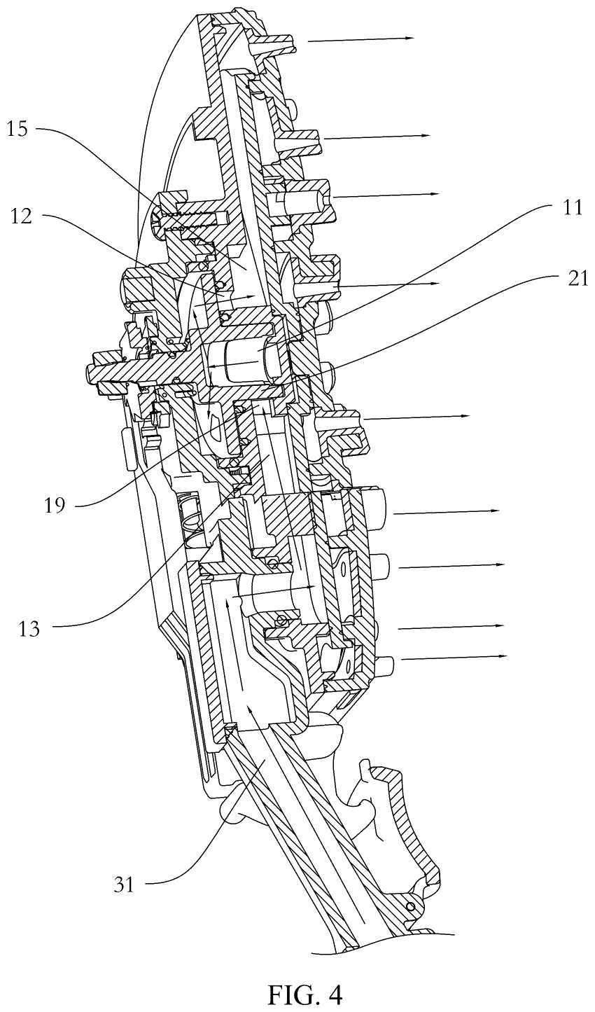

FIG. 5 is a schematic enlarged view of A shown in FIG. 3;

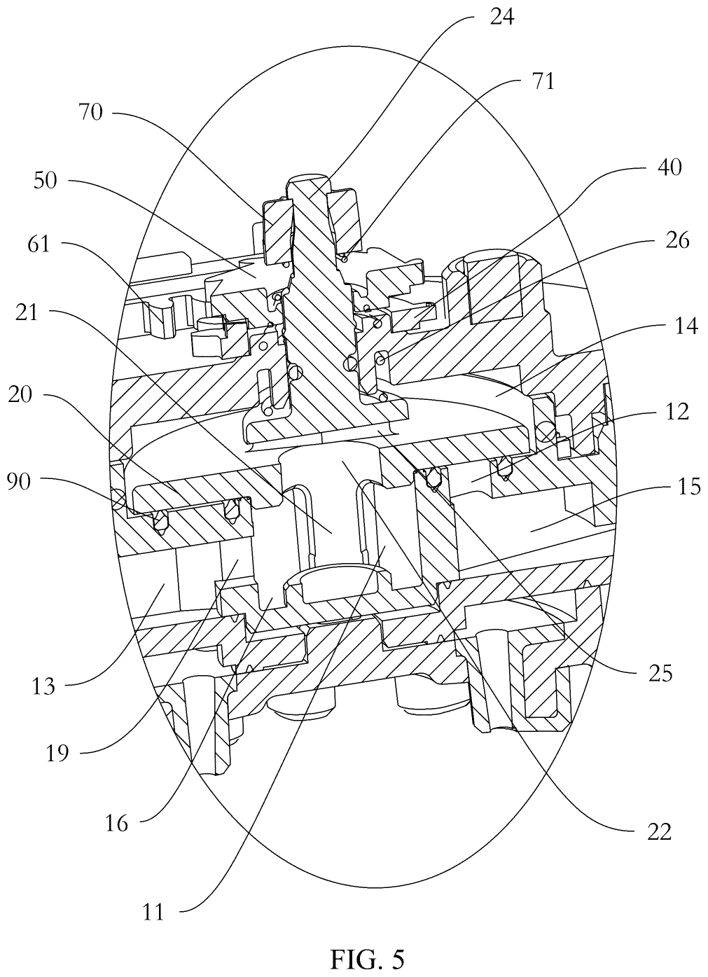

FIG. 6 is a schematic view of a water outlet body according to the present disclosure;

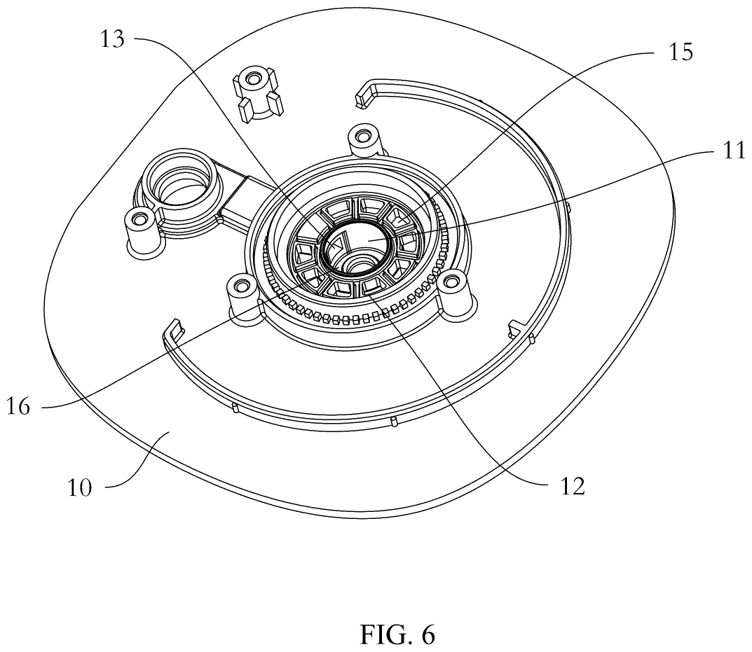

FIG. 7 is a schematic view illustrating cooperation of a water distribution disc according to the present disclosure;

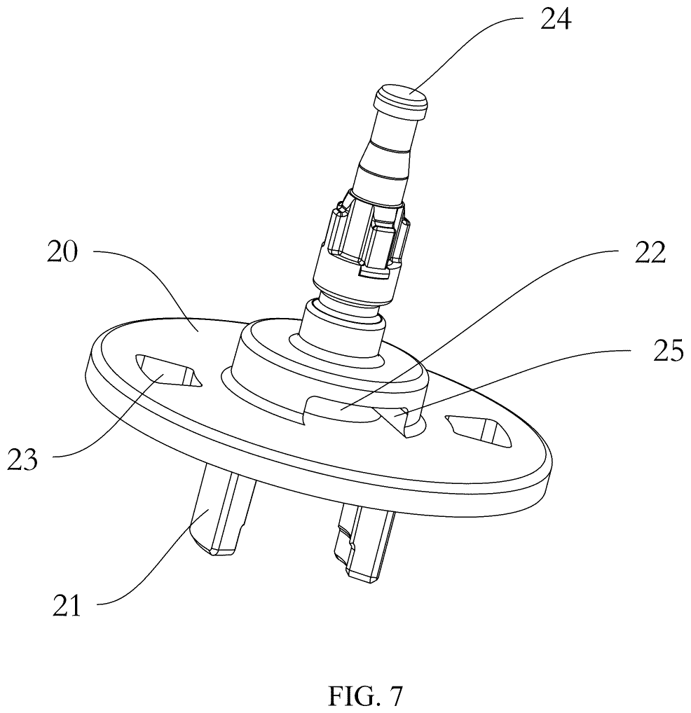

FIG. 8 is a schematic view of a gear according to the present disclosure; and

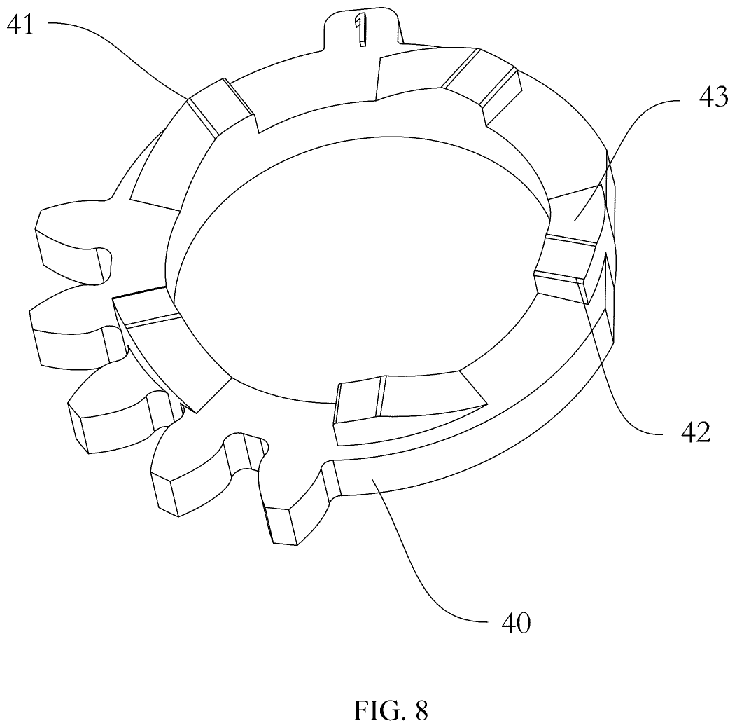

FIG. 9 is a schematic view of a ratchet wheel according to the present disclosure.

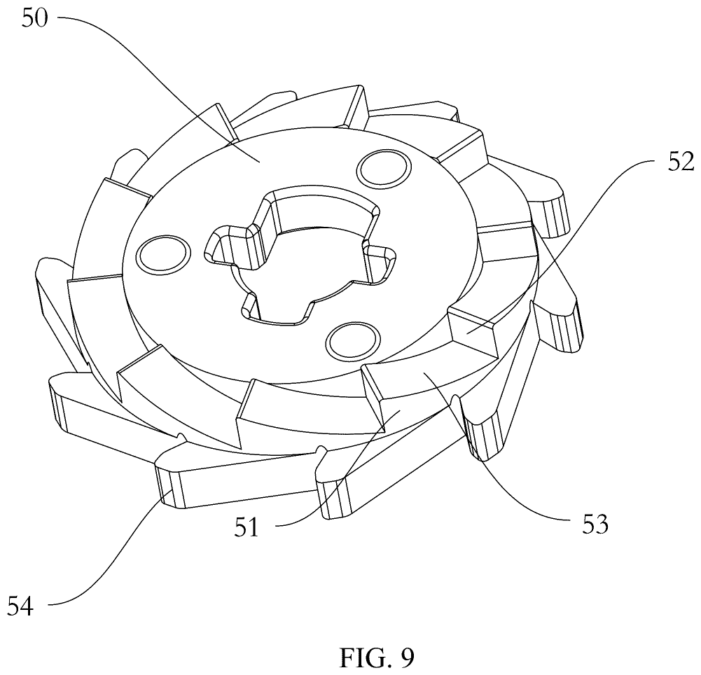

### DETAILED DESCRIPTION OF THE EMBODIMENTS

In order to make the objectives, technical solutions, and advantages of the implementations of the present disclosure clearer, the technical solutions in the implementations of the present disclosure will be clearly and completely described below in conjunction with the accompanying drawings in the implementations of the present disclosure. Obviously, the described implementations are some, rather than all of the implementations of the present disclosure. On the basis of the implementations of the present disclosure, all other implementations obtained by a person of ordinary skill in the art without making creative efforts shall fall within the protection scope of the present disclosure. Therefore, the detailed description of the implementations of the present disclosure in the drawings is not intended to limit the protection scope of the present disclosure, but merely represent the selected implementations of the present disclosure. On the basis of the implementations of the present disclosure, all other implementations obtained by a person of ordinary skill in the art without making creative efforts shall fall within the protection scope of the present disclosure.

It should be understood that, in the description of the present disclosure, the terms such as “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, and “anticlockwise” are intended to indicate orientation or position relationships shown in accompanying drawings, and these terms are merely intended to facilitate the description of the present disclosure or simplify the description, rather than to indicate or imply that the mentioned apparatus or elements must have the specific orientation or be constructed and operated in the specific orientation. Therefore, these terms may not be construed as a limitation to the present disclosure.

In addition, the terms “first” and “second” are merely intended for a purpose of description, and shall not be understood as an indication or implication of relative importance or implicit indication of a quantity of indicated technical features. Thus, features defined with “first” and “second” may explicitly or implicitly include one or more of the features. In the description of the present disclosure, “a plurality of” means two or more, unless otherwise specifically defined.

In the present disclosure, unless otherwise clearly specified, the terms “installation”, “interconnection”, “connection” and “fixation” etc. are intended to be understood in a broad sense. For example, the “connection” may be a fixed connection, removable connection or integral connection; may be a mechanical connection or electrical connection; may be a direct connection or indirect connection using a medium; and may be a communication or interaction between two elements. Those of ordinary skill in the art may understand specific meanings of the above terms in the present disclosure based on a specific situation.

In the present disclosure, unless otherwise expressly specified, when it is described that a first feature is “above” or “under” a second feature, it may indicate that the first feature is in direct contact with the second feature, or that the first feature and the second feature are not in direct contact with each other but are in contact via another feature between them. In addition, that the first feature is “over”, “above”, and “on” the second feature includes that the first feature is directly above and diagonally above the second feature, or simply indicates that a horizontal height of the first feature is larger than that of the second feature. “A first feature is under and below a second feature” includes “the first feature is directly under or obliquely under the second feature” or simply means that “the first feature is lower than the second feature in horizontal height”.

Referring to figures in the description, a one-button shower head with a pause function includes water outlet body 10 having a middle provided with cavity 11. Water outlet 12 and water channel 13 configured to communicate with the cavity are formed in the water outlet body. The water outlet and the water channel are distributed on the water outlet body at an outer circumferential side of the cavity. The water outlet and the water channel are annularly distributed on an outer circumference of the cavity. This can make the whole water outlet body more compact, thereby laying a foundation for a smaller design of the whole shower head product. The one-button shower head with a pause function further includes upper cavity 14 configured to communicate with the cavity. Water distribution disc 20 configured to rotate is provided in the upper cavity. A lower end of the water distribution disc can be cooperatively connected to an upper end of the cavity. In other words, the lower end of the water distribution disc is in sealing fit with the upper end of the cavity. Baffle 21 configured to obstruct water outlet end 19 of the water channel (or a water inlet of the water channel communicating with the cavity) is provided on the water distribution disc. When the baffle cooperates with the water outlet end of the water channel, a paused state is achieved. Passage 22 configured to communicate the cavity with the upper cavity is provided at a middle of the water distribution disc. Water flows to the cavity from the water channel transversely, and the water distribution disc is in sealing fit with the water outlet body. Consequently, the water only can flow upward from the cavity, and flows through the passage from the lower end of the water distribution disc to an upper end of the water distribution disc, namely to the upper cavity. Water passing port 23 configured to communicate with the water outlet is formed in the water distribution disc and located at a side of the passage. The water flows to the water outlet through the water passing port. There may be a plurality of water outlets. Each of the water outlets corresponds to waterway 15 of a corresponding water outlet spray. The water flows down from the water outlet, and then flows out transversely. In an embodiment, a water flow coming into the water channel and a water flow coming out of the waterway may fall onto a same transverse plane. This can reduce the thickness of the shower head well, and make the shower head smaller. Herein, the downward water outlet direction is used as a reference direction basically for description.

Preferably, at least two water outlets are formed in an upper end surface of the water outlet body. A specific number of the water outlets and a specific number of the waterways depend on a specific amount of functional water required by the shower head. The water outlets respectively correspond to waterways 15 of different water outlet sprays in the water outlet body. The water outlets, the waterways and the water channel are annularly distributed at the outer circumferential side of the cavity, such that the whole shower head is more compact. Sealing ring 90 configured to be in sealing fit with a lower end surface of the water distribution disc is provided at the water outlets and an opening of the upper end of the cavity, thereby preventing the whole shower head from leaking. A water flow in the cavity can only flow through the passage, the water passing port and the water outlets sequentially to the waterways.

In use, the water outlet end of the water channel can be connected transversely to the cavity. The baffle can be inserted vertically into the cavity and rotates in the cavity synchronously with the water distribution disc. The passage is provided at an inner circumferential side of the baffle. Since the waterway and the baffle cooperate laterally, the water distribution disc and the baffle suffers a tangential force in rotation, and the water flow neither generates an excessive acting force on the water distribution disc, nor causes a sense of large force in the switching. A lower end of the cavity is further provided with annular groove 16, and a lower end of the baffle can be inserted into the annular groove. A sidewall of the annular groove may abut against the baffle. This can prevent the baffle from deforming for a water pressure, can reduce the thickness of the baffle, and also lays a foundation for the smaller design of the whole shower head product.

Preferably, the one-button shower head with a pause function further includes water inlet body 30. The water inlet body can be cooperatively connected to the water outlet body. The upper cavity 14 can be formed between the water inlet body and the water outlet body. The water distribution disc is provided in the upper cavity and can be in sealing fit with the water outlet body, which may refer to a position of the sealing ring specifically. Water inlet passage 31 is provided in the water inlet body. The water inlet passage can communicate with the water channel. In this way, the water flow in the water inlet passage is drained to the water outlet body.

Further, the lower end of the water distribution disc is provided with the baffle configured to be inserted into the cavity, and an upper end of the water distribution disc is provided with rotating shaft 24. An opening configured to allow an end of the rotating shaft to extend out is formed in the water inlet body at the upper cavity. Likewise, sealing fit is provided between the opening and the rotating shaft. The rotating shaft can rotate synchronously with the water distribution disc. Preferably, the rotating shaft is coaxial with the water distribution disc and the passage. Transverse flow channel 25 is provided between the rotating shaft and the water distribution disc. This can make the water in the cavity flow to the upper cavity well. The flow channel can communicate with the passage arranged vertically. An end of the rotating shaft can extend out of the upper cavity and can be connected to a drive mechanism. The drive mechanism is configured to drive the rotating shaft to rotate.

The following description is made on the driving member. The drive mechanism includes ratchet wheel 50 and gear 40 cooperating with each other. The ratchet wheel may be connected to the rotating shaft with a key and a key groove. The ratchet wheel is sleeved on the rotating shaft and can rotate synchronously with the rotating shaft. Likewise, the gear is also sleeved on the rotating shaft. When the gear only rotates relative to the water inlet body, the gear in rotation can drive the rotating shaft indirectly to rotate. When the gear rotates reversely, the rotating shaft cannot be driven and also rotates reversely therewith. First bump 41 is arranged annularly at an end surface of the gear facing the ratchet wheel. Second bump 51 is arranged annularly at an end surface of the ratchet wheel facing the gear. First mating surface 42 is provided at one side of the first bump. Second mating surface 52 is provided at one side of the second bump. Through cooperation between the first mating surface and the second mating surface, the gear can drive the ratchet wheel to rotate synchronously. Through abutment between the first mating surface and the second mating surface, the gear can drive the ratchet wheel for rotation, which can be referred to as forward rotation.

When the gear rotates reversely, latch 70 is further provided on the rotating shaft. The latch is configured to limit the gear and the ratchet wheel on the rotating shaft. The ratchet wheel is provided above the gear. Spring 71 is further provided between the ratchet wheel and the latch. The ratchet wheel can further move axially along the rotating shaft. This can ensure that the spring always provides an acting force for axial movement of the ratchet wheel toward the gear, although the ratchet wheel and the gear can cause relative axial movement and separation. First oblique surface 43 is provided at the other side of the first bump. Second oblique surface 53 is provided at the other side of the second bump. Through cooperation between the first oblique surface and the second oblique surface, the gear can rotate, and the ratchet wheel moves axially without rotation. When the gear rotates reversely, through the cooperation between the first oblique surface and the second oblique surface, since the gear does not move axially relative to the rotating shaft, the ratchet wheel moves axially to separate from the gear, thereby compressing the spring. In this state, the ratchet wheel, the rotating shaft, the water distribution disc, and the baffle do not rotate, until reverse rotation of the gear ended. Under an action of the spring, the ratchet wheel moves axially to the gear, such that the first mating surface and the second mating surface cooperate in advance. This is convenient for the gear to drive the ratchet wheel, the rotating shaft, the water distribution disc, and the baffle to rotate in next time.

More specifically, the drive mechanism further includes moving member 60. Rack 61 configured to drive the gear to rotate is provided on the moving member. Reset spring 62 is further provided between the moving member and the water inlet body. The rack moves back and forth through the reset spring. In other words, when the rack advances for a distance, the gear, the ratchet wheel, and the rotating shaft are driven to rotate. Then, under an action of the reset spring, the gear rotates reversely, and the gear and the moving member move back to an initial position. In this way, the moving member can be driven all the time, thereby driving the ratchet wheel and the rotating shaft to rotate unidirectionally. The drive mechanism further includes elastic piece 63. One end of the elastic piece is connected to the water inlet body, and the other end of the elastic piece is configured to cooperate with ratchet 54 of the ratchet wheel to prevent the ratchet wheel from rotating reversely.

Further, the one-button shower head with a pause function further includes connector 81. A middle of the connector is hinged to the water inlet body. One end of the connector is connected to the moving member, and the other end of the connector is cooperatively connected to button 82. Pressing the button can drive the connector to rotate, such that the moving member is driven to move, and the ratchet wheel, the rotating shaft, the water distribution disc, and the baffle rotate a certain angle. After the button is released, under an action of the reset spring, the moving member, the connector, and the button are restored, while the ratchet wheel (which moves axially), the rotating shaft, the water distribution disc, and the baffle do not rotate. By pressing the button again, the ratchet wheel, the rotating shaft, the water distribution disc, and the baffle rotate a certain angle again. In this way, the function is switched.

The present disclosure is described below in more detail: The water inlet body and the water outlet body are in the sealing fit. First of all, the water flows through the water inlet passage of the water inlet body to the cavity connected to the water outlet body, and then flows to the upper cavity cooperatively formed by the water outlet body and the water inlet body. The water distribution disc is provided between the cavity and the upper cavity. The middle of the water distribution disc is a hollow to form the passage, such that the water in the cavity can flow through the passage at the hollow of the water distribution disc to the upper cavity. In addition, the baffle is provided under the water distribution disc. When the baffle rotates to the water inlet end of the water channel, a side of the baffle is tightly attached to a side of the water inlet end of the water channel, such that the water is nearly obstructed, and only a small amount of water flows to the upper cavity through a gap between the inner circumferential wall of the cavity and the outer circumferential wall of the baffle. Meanwhile, the sidewall of the annular groove can support the baffle, thereby preventing the problem that the baffle deforms and moves back for the impact of a water inlet pressure, and the gap between the inner circumferential wall of the cavity and the outer circumferential wall of the baffle becomes larger to cause a larger water flow. With side sealing, the water distribution disc suffers the tangential force in rotation, so there is no sense of large force in switching. Then, the water passing port communicating with the waterways of different sprays is formed in the water distribution disc. The water distribution disc and the water outlet body are sealed through a special-shaped sealing ring. When the button is pressed, the button pushes the moving member and the rack through the connector to move forward. The connector takes an intermediate transmission effect. The rack pushes the drive gear to rotate. The first bump on the upper end surface of the drive gear pushes the second bump on the lower end surface of the ratchet wheel cooperating with the gear to rotate. The water distribution disc cooperating with the ratchet wheel is driven synchronously to rotate. Through rotation of the water distribution disc, different water outlet functions are switched, and the paused state is formed. Under an action of a compressive force of cylindrical spring 26, the bottom of the water distribution disc is attached and sealed with the special-shaped sealing ring. Because of the reset spring between the moving member, the rack, and the water inlet body, when the button is pressed, the reset spring is compressed. When the button is released, the reset spring is released under an action of a restoring force, thereby pushing the rack to move back, and pushing the button through the intermediate connector to the original position. While moving back, the rack drives the drive gear to rotate. The ratchet wheel does not rotate. Preferably, one end of the button is hinged to the water inlet body.

The above explanation shows and describes several preferred embodiments of the present disclosure. But as mentioned above, it should be understood that the present disclosure is not limited to the form disclosed herein, and the explanation should not be regarded as an exclusion of other embodiments. Various combinations, modifications and environments can be achieved through the above guides and technologies or knowledge in related fields within the scope of conception of the present disclosure described herein. Modifications and changes made by those skilled in the art without departing from the spirit and scope of the present disclosure should fall within the protection scope of the appended claims of the present disclosure.

1. A one-button shower head with a pause function, comprising:
a water outlet body having a middle provided with a cavity, and
an upper cavity configured to communicate with the cavity;
wherein a water outlet and a water channel are formed in the water outlet body, wherein the water channel is configured to communicate with the cavity; the water outlet and the water channel are distributed on the water outlet body at an outer circumferential side of the cavity; a water distribution disc configured to rotate is provided in the upper cavity; a lower end of the water distribution disc is cooperatively connected to an upper end of the cavity; a baffle configured to obstruct a water outlet end of the water channel is provided on the water distribution disc; a passage configured to communicate the cavity with the upper cavity is provided at a middle of the water distribution disc; and a water passing port configured to communicate with the water outlet is formed in the water distribution disc and located at a side of the passage.

2. The one-button shower head with the pause function according to claim 1, wherein at least two water outlets are formed in an upper end surface of the water outlet body; the at least two water outlets respectively correspond to waterways of different water outlet sprays in the water outlet body; the at least two water outlets, the waterways and the water channel are annularly distributed at the outer circumferential side of the cavity; a sealing ring configured to be in sealing fit with a lower end surface of the water distribution disc is provided at the at least two water outlets and an opening of the upper end of the cavity; and a water flow in the cavity only flows through the passage, the water passing port and the at least two water outlets sequentially to the waterways.

3. The one-button shower head with the pause function according to claim 2, wherein the water outlet end of the water channel is connected transversely to the cavity; the baffle is inserted vertically into the cavity and rotates in the cavity synchronously with the water distribution disc; and the passage is provided at an inner circumferential side of the baffle.

4. The one-button shower head with the pause function according to claim 3, wherein a lower end of the cavity is further provided with an annular groove, and a lower end of the baffle is inserted into the annular groove.

5. The one-button shower head with the pause function according to claim 1, further comprising a water inlet body, wherein the water inlet body is cooperatively connected to the water outlet body; the upper cavity is formed between the water inlet body and the water outlet body; the water distribution disc is provided in the upper cavity and is in sealing fit with the water outlet body; a water inlet passage is provided in the water inlet body; and the water inlet passage communicates with the water channel.

6. The one-button shower head with the pause function according to claim 5, wherein the lower end of the water distribution disc is provided with the baffle configured to be inserted into the cavity, and an upper end of the water distribution disc is provided with a rotating shaft; the rotating shaft rotates synchronously with the water distribution disc; a transverse flow channel is provided between the rotating shaft and the water distribution disc; the transverse flow channel communicates with the passage arranged vertically; an end of the rotating shaft extends out of the upper cavity and is connected to a drive mechanism; and the drive mechanism is configured to drive the rotating shaft to rotate.

7. The one-button shower head with the pause function according to claim 6, wherein the drive mechanism comprises a ratchet wheel and a gear cooperating with each other; the ratchet wheel is sleeved on the rotating shaft and rotates synchronously with the rotating shaft; a first bump is arranged annularly at an end surface of the gear facing the ratchet wheel; a second bump is arranged annularly at an end surface of the ratchet wheel facing the gear; a first mating surface is provided at a first side of the first bump; a second mating surface is provided at a first side of the second bump; and through cooperation between the first mating surface and the second mating surface, the gear drives the ratchet wheel to rotate synchronously.

8. The one-button shower head with the pause function according to claim 7, wherein a latch is further provided on the rotating shaft; the latch is configured to limit the gear and the ratchet wheel on the rotating shaft; the ratchet wheel is provided above the gear; a spring is further provided between the ratchet wheel and the latch; the ratchet wheel is further configured to move axially along the rotating shaft; a first oblique surface is provided at a second side of the first bump; a second oblique surface is provided at a second side of the second bump; through cooperation between the first oblique surface and the second oblique surface, the gear rotates, and the ratchet wheel moves axially without rotation.

9. The one-button shower head with the pause function according to claim 8, wherein the drive mechanism further comprises a moving member and an elastic piece; a rack configured to drive the gear to rotate is provided on the moving member; a reset spring is further provided between the moving member and the water inlet body; the rack moves back and forth through the reset spring; and a first end of the elastic piece is connected to the water inlet body, and a second end of the elastic piece is configured to cooperate with a ratchet of the ratchet wheel to prevent the ratchet wheel from rotating reversely.

10. The one-button shower head with the pause function according to claim 9, further comprising a connector, wherein a middle of the connector is hinged to the water inlet body; and a first end of the connector is connected to the moving member, and a second end of the connector is cooperatively connected to a button.

11. The one-button shower head with the pause function according to claim 2, further comprising a water inlet body, wherein the water inlet body is cooperatively connected to the water outlet body; the upper cavity is formed between the water inlet body and the water outlet body; the water distribution disc is provided in the upper cavity and is in sealing fit with the water outlet body; a water inlet passage is provided in the water inlet body; and the water inlet passage communicates with the water channel.

12. The one-button shower head with the pause function according to claim 3, further comprising a water inlet body, wherein the water inlet body is cooperatively connected to the water outlet body; the upper cavity is formed between the water inlet body and the water outlet body; the water distribution disc is provided in the upper cavity and is in sealing fit with the water outlet body; a water inlet passage is provided in the water inlet body; and the water inlet passage communicates with the water channel.

13. The one-button shower head with the pause function according to claim 4, further comprising a water inlet body, wherein the water inlet body is cooperatively connected to the water outlet body; the upper cavity is formed between the water inlet body and the water outlet body; the water distribution disc is provided in the upper cavity and is in sealing fit with the water outlet body; a water inlet passage is provided in the water inlet body; and the water inlet passage communicates with the water channel.

14. The one-button shower head with the pause function according to claim 11, wherein the lower end of the water distribution disc is provided with the baffle configured to be inserted into the cavity, and an upper end of the water distribution disc is provided with a rotating shaft; the rotating shaft rotates synchronously with the water distribution disc; a transverse flow channel is provided between the rotating shaft and the water distribution disc; the transverse flow channel communicates with the passage arranged vertically; an end of the rotating shaft extends out of the upper cavity and is connected to a drive mechanism; and the drive mechanism is configured to drive the rotating shaft to rotate.

15. The one-button shower head with the pause function according to claim 14, wherein the drive mechanism comprises a ratchet wheel and a gear cooperating with each other; the ratchet wheel is sleeved on the rotating shaft and rotates synchronously with the rotating shaft; a first bump is arranged annularly at an end of the gear facing the ratchet wheel; a second bump is arranged annularly at an end of the ratchet wheel facing the gear; a first mating surface is provided at a first side of the first bump; a second mating surface is provided at a first side of the second bump; and through cooperation between the first mating surface and the second mating surface, the gear drives the ratchet wheel to rotate synchronously.

16. The one-button shower head with the pause function according to claim 15, wherein a latch is further provided on the rotating shaft; the latch is configured to limit the gear and the ratchet wheel on the rotating shaft; the ratchet wheel is provided above the gear; a spring is further provided between the ratchet wheel and the latch; the ratchet wheel is further configured to move axially along the rotating shaft; a first oblique surface is provided at a second side of the first bump; a second oblique surface is provided at a second side of the second bump; through cooperation between the first oblique surface and the second oblique surface, the gear rotates, and the ratchet wheel moves axially without rotation.

17. The one-button shower head with the pause function according to claim 16, wherein the drive mechanism further comprises a moving member and an elastic piece; a rack configured to drive the gear to rotate is provided on the moving member; a reset spring is further provided between the moving member and the water inlet body; the rack moves back and forth through the reset spring; and a first end of the elastic piece is connected to the water inlet body, and a second end of the elastic piece is configured to cooperate with a ratchet of the ratchet wheel to prevent the ratchet wheel from rotating reversely.

18. The one-button shower head with the pause function according to claim 17, further comprising a connector, wherein a middle of the connector is hinged to the water inlet body; and a first end of the connector is connected to the moving member, and a second end of the connector is cooperatively connected to a button.

19. The one-button shower head with the pause function according to claim 12, wherein the lower end of the water distribution disc is provided with the baffle configured to be inserted into the cavity, and an upper end of the water distribution disc is provided with a rotating shaft; the rotating shaft rotates synchronously with the water distribution disc; a transverse flow channel is provided between the rotating shaft and the water distribution disc; the transverse flow channel communicates with the passage arranged vertically; an end of the rotating shaft extends out of the upper cavity and is connected to a drive mechanism; and the drive mechanism is configured to drive the rotating shaft to rotate.

20. The one-button shower head with the pause function according to claim 19, wherein the drive mechanism comprises a ratchet wheel and a gear cooperating with each other; the ratchet wheel is sleeved on the rotating shaft and rotates synchronously with the rotating shaft; a first bump is arranged annularly at an end of the gear facing the ratchet wheel; a second bump is arranged annularly at an end of the ratchet wheel facing the gear; a first mating surface is provided at a first side of the first bump; a second mating surface is provided at a first side of the second bump; and through cooperation between the first mating surface and the second mating surface, the gear drives the ratchet wheel to rotate synchronously.
